(19) United States
(12) Patent Application Publication
(10) Pub. No.: US 2025/0255704 A1
(43) Pub. Date: Aug. 14, 2025

(54) NEGATIVE-PRESSURE SUCTION DEVICE FOR TONSILLOLITH

(71) Applicant: Kun Yang, Changzhi (CN)

(72) Inventor: Kun Yang, Changzhi (CN)

(21) Appl. No.: 18/611,714

(22) Filed: Mar. 21, 2024

(30) Foreign Application Priority Data
Feb. 9, 2024 (CN) 202420290830.1

(51) Int. Cl. A61C 17/08

(52) U.S. Cl. CPC A61C 17/08

(57) ABSTRACT

This invention is about oral cavity cleansing, and specifically, to a negative-pressure suction device for a tonsillolith, including: an electric base, a saliva bin, and a suction pipe, where a cavity is disposed in the electric base, a vacuum pump is disposed in the cavity, the vacuum pump is provided with a first connecting pipe and a second connecting pipe, the first connecting pipe communicates with the saliva bin, and the second connecting pipe communicates with the cavity; and the suction pipe communicates with the saliva bin. Because the first connecting pipe communicates with the saliva bin, the vacuum pump sucks air through the first connecting pipe, the saliva bin, and the suction pipe, to cause negative pressure at a local area, thereby sucking a concretion. The sucked concretion and saliva slide along a wall of the suction pipe to a bottom of the saliva bin for storage.

The application claims priority to Chinese patent application No. 202420290830.1, filed on Feb. 9, 2024, the entire contents of which are incorporated herein by reference.

### TECHNICAL FIELD

This application relates to the technical field of oral cavity cleansing, and specifically, to a negative-pressure suction device for a tonsillolith.

### BACKGROUND

Tonsilloliths threaten oral health. However, with few available devices among daily necessities, it is difficult for people to remove a concretion by their own efforts to carry out daily cleansing and care, and usually, they can do nothing but wait until their conditions turn severer, and go to hospitals for treatments.

As an example of this, U.S. Pat. No. 8,425,479 B2 discloses an oral debris removal device, this device include: a suction unit; light source positioned and a tube that can enter the oral cavity, this device can removes tonsil stones by using a vacuum method.however, the inconvenience of this device lies in its inability to be operated by individual consumers and the lack of angle adjustment. It also doesn't cater adequately to different oral sizes when extracting tonsil stones.

U.S. pat No. US 2016/0361078 A1 discloses an Oral debris extractor, the extractor includes a bulb of resilient material and a tube that can enter the oral cavity, This extractor generates a vacuum suction manually, extracting tonsil stones from the affected area. While this device allows for individual consumer operation, the manual working mode is not convenient and it is unable to precisely control the magnitude of the vacuum suction force.

### SUMMARY

This application provides a negative-pressure suction device for a tonsillolith, to help people carry out daily cleansing and care.

The negative-pressure suction device for a tonsillolith in this application includes an electric base, a saliva bin, and a suction pipe;
a cavity is disposed in the electric base, a vacuum pump is disposed in the cavity, the vacuum pump is provided with a first connecting pipe and a second connecting pipe, the first connecting pipe communicates with the saliva bin, and the second connecting pipe communicates with the cavity; and the suction pipe communicates with the saliva bin.

In some embodiments, the negative-pressure suction device for a tonsillolith further includes a suction head, where the suction head is a bent pipe, the suction head is sleeved on the suction pipe, and the suction pipe communicates with the suction head.

In some embodiments, the electric base includes a front housing and a rear housing, the front housing is engaged with the rear housing to form the cavity, a circuit board and a battery are further installed in the cavity, a charging port, a switch, and a gear button are disposed on the circuit board, and a switch hole is opened and a gear button column is disposed on the front housing.

In some embodiments, a conical pipe is disposed at a nozzle of the first connecting pipe, a bottom of the saliva bin is sleeved on the conical pipe and is not in tight contact with the conical pipe, and a gap is formed between the bottom of the saliva bin and the conical pipe; and an air duct that penetrates through a bottom plate is disposed on the bottom plate of the saliva bin, and the first connecting pipe, the gap, and the saliva bin communicate with each other through the air duct.

In some embodiments, the saliva bin includes a cylindrical bin pipe and a conical bin head, an upper part of the conical bin head is used for disposing the suction pipe, and a lower part of the conical bin head is detachably connected with the cylindrical bin pipe.

In some embodiments, the suction pipe is detachably connected with the suction head.

In some embodiments, curvature of the suction head includes 45 degrees, 75 degrees, 90 degrees, and 135 degrees.

According to the foregoing embodiment, because the first connecting pipe communicates with the saliva bin, the vacuum pump sucks air through the first connecting pipe, the saliva bin, and the suction pipe, to cause negative pressure at a local area, thereby sucking a concretion. The sucked concretion and saliva slide along a wall of the suction pipe to a bottom of the saliva bin for storage.

### BRIEF DESCRIPTION OF DRAWINGS

FIG. 1 is a schematic structural diagram of a negative-pressure suction device for a tonsillolith according to an embodiment;

FIG. 2 is a schematic diagram of an electric base and a saliva bin according to an embodiment;

FIG. 3 is a first schematic diagram of an electric base and a cylindrical bin pipe according to an embodiment;

FIG. 4 is a second schematic diagram of an electric base and a cylindrical bin pipe according to an embodiment;

FIG. 5 is a first exploded view of an electric base according to an embodiment; and

FIG. 6 is a second exploded view of an electric base according to an embodiment.

### DESCRIPTION OF EMBODIMENTS

This application is further described in detail below by using specific embodiments in conjunction with the accompanying drawings. Herein, associated similar element numbers are used for similar elements in different embodiments. In the following embodiments, many details are described to facilitate better understanding of this disclosure. However, those skilled in the art may readily understand that some features may be omitted in a different case, or may be replaced by another element, material, and method. In some cases, some operations related to this application are not shown or described in this specification, this is intended to prevent excessive descriptions from dominating a core part of this application, and for those skilled in the art, it is inessential to describe these related operations in detail, and they can fully understand the related operations based on the descriptions in this specification and general technical knowledge in the art.

In addition, features, operations, or characteristics described in this specification may be combined into various embodiments in any proper manner.

Serial numbers of components such as “first”, “second”, and the like herein are only used to distinguish between the described objects, and do not have any sequential or technical meaning. Unless otherwise specified, a “connection” and a “communication” mentioned in this application include both direct and indirect connections (communications).

### Embodiment 1

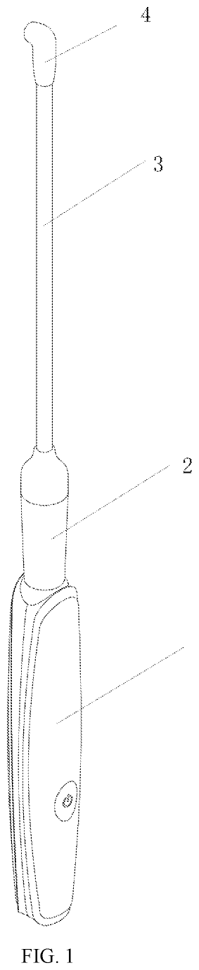

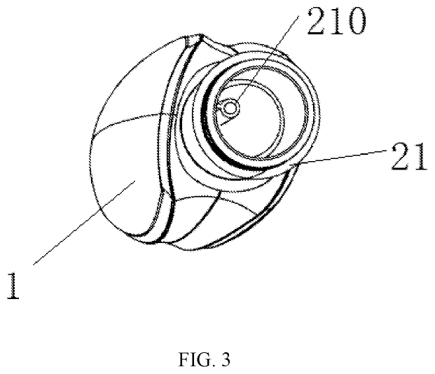

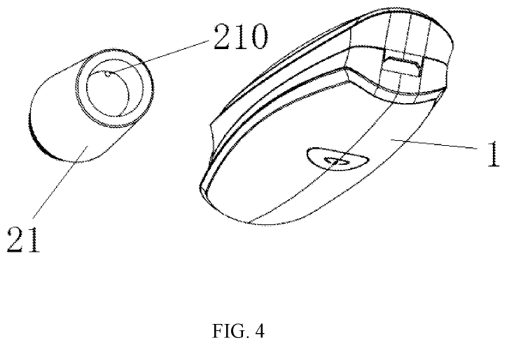

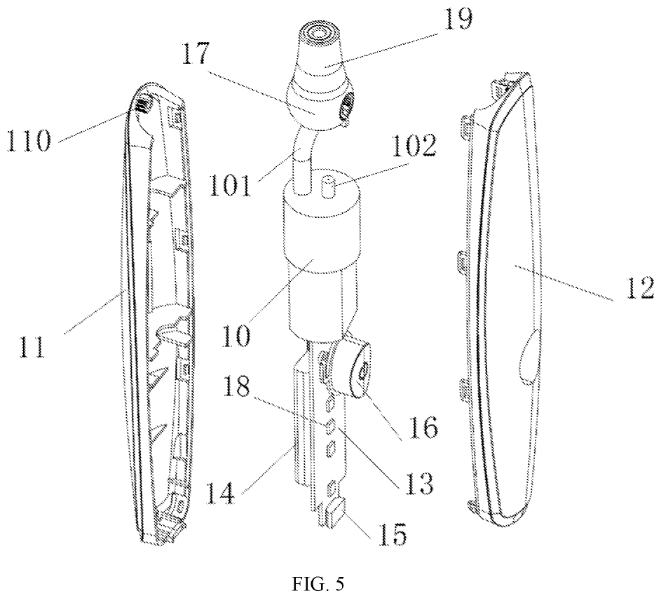

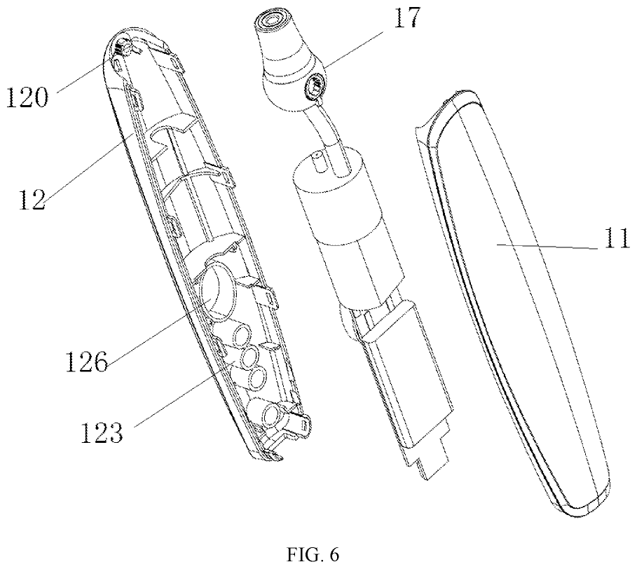

Referring to FIG. 1 to FIG. 6, a negative-pressure suction device for a tonsillolith in this application includes an electric base 1, a saliva bin 2, and a suction pipe 3. A cavity is disposed in the electric base 1, a vacuum pump 10 is disposed in the cavity, the vacuum pump 10 is provided with a first connecting pipe 101 and a second connecting pipe 102, the first connecting pipe 101 communicates with the saliva bin 2, and the second connecting pipe 102 communicates with the cavity. The suction pipe 3 communicates with the saliva bin 2. Because the first connecting pipe 101 communicates with the saliva bin 2, the vacuum pump 10 sucks air through the first connecting pipe 101, the saliva bin 2, and the suction pipe 3, to cause negative pressure at a local area, thereby sucking a concretion. The sucked concretion and saliva slide along a wall of the suction pipe 3 to a bottom of the saliva bin for storage.

In some embodiments, the negative-pressure suction device for a tonsillolith further includes a suction head 4, the suction head 4 is a bent pipe, the suction head 4 is sleeved on the suction pipe 3, and the suction pipe 3 communicates with the suction head 4, to facilitate suction of a concretion on a wall of a tonsil. Curvature of the suction head 4 can be set to different degrees such as 45 degrees, 75 degrees, 90 degrees, and 135 degrees, to suck concretions at different positions. In some specific embodiments, the suction pipe 3 is detachably connected with the suction head 4. After detachment, a suction head 4 with different curvature can be used for replacement conveniently.

In some embodiments, the electric base 1 includes a front housing 12 and a rear housing 11, the front housing 12 is engaged with the rear housing 11 to form the cavity, a circuit board 13 and a battery 14 are further installed in the cavity, a charging port 15, a switch 16, and a gear button 18 are disposed on the circuit board 13, the charging port 15, the circuit board 13, and the battery 14 are connected, and a switch hole 126 is opened and a gear button column 123 is disposed on the front housing.

In some embodiments, a conical pipe 19 is disposed at a nozzle of the first connecting pipe 101, a bottom of the saliva bin 2 is sleeved on the conical pipe 19 and is not in tight contact with the conical pipe 19, and a gap is formed between the bottom of the saliva bin 2 and the conical pipe 19; and an air duct 210 that penetrates through a bottom plate is disposed on the bottom plate of the saliva bin 2, and the first connecting pipe 101, the gap, and the saliva bin 2 communicate with each other through the air duct 210. The vacuum pump 10 sucks air through the first connecting pipe 101, the gap, the air duct 210, the saliva bin 2, the suction pipe 3, and the suction head 4, to cause negative pressure at a local area, thereby sucking a concretion. Because the air duct 210 penetrates through the bottom plate of the saliva bin 2, a distal end of the air duct 210 is higher than the bottom plate of the saliva bin 2, so that the sucked concretion and saliva slide along a wall of the suction pipe 3 to the bottom of the saliva bin 2 for storage, instead of flowing into the air duct 210 or blocking the air duct 210.

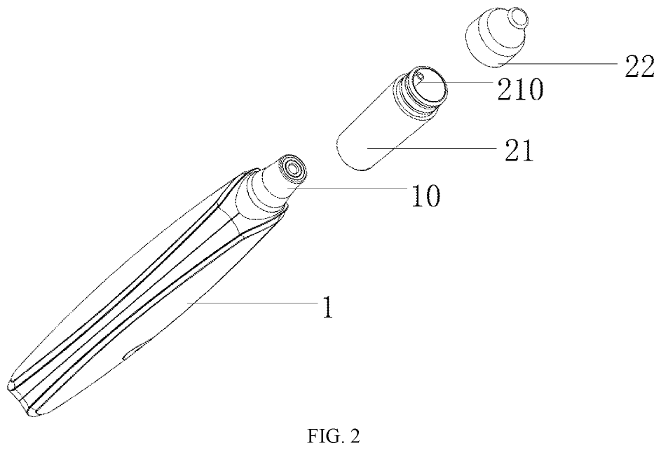

Referring to FIG. 2, in a specific embodiment, the saliva bin 2 includes a cylindrical bin pipe 21 and a conical bin head 22, an upper part of the conical bin head 22 is used for disposing the suction pipe 3, and a lower part of the conical bin head 22 is detachably connected with the cylindrical bin pipe 21. After detachment, the concretion and the saliva stored in the saliva bin 2 can be removed; and a bottom of the cylindrical bin pipe 21 is sleeved on the conical pipe 19 and is not in tight contact with the conical pipe 19.

In some embodiments, a hollow connecting ball 17 is sleeved on the first connecting pipe 101, mounting holes are disposed in the connecting ball 17, and the mounting holes are configured to be fitted with a front mounting column 120 disposed on the front housing 12 and a rear mounting column 110 disposed on the rear housing 11.

### Embodiment 2

This application provides another negative-pressure suction device for a tonsillolith, which may not be provided with a saliva bin 2 and only includes an electric base 1, a suction pipe 3, and a suction head 4. The first connecting pipe 101 directly communicates with the air duct 210, and the vacuum pump 10 sucks air through the first connecting pipe 101, the suction pipe 3, and the suction head 4, to cause negative pressure at a local area, thereby sucking a concretion. The negative-pressure suction device for a tonsillolith can also help people carry out daily cleansing and care with respect to the tonsillolith, but a nozzle of the first connecting pipe 101 may be blocked.

### Embodiment 3

This application provides yet another negative-pressure suction device for a tonsillolith, which may not be provided with a saliva bin 2 and a suction head 4 and only includes an electric base 1 and a suction pipe 3. The first connecting pipe 101 directly communicates with the air duct 210, and the vacuum pump 10 sucks air through the first connecting pipe 101 and the suction pipe 3, to cause negative pressure at a local area, thereby sucking a concretion. The negative-pressure suction device for a tonsillolith can also help people carry out daily cleansing and care with respect to the tonsillolith, but a nozzle of the first connecting pipe 101 may be blocked, and the negative-pressure suction device for a tonsillolith cannot suck concretions at some positions due to a lack of proper angles, and therefore, is inconvenient to use.

This application is described above by using a specific example. This is only used to help understand this application instead of limiting this application. Those skilled in the art to which this application belongs can also make several simple deductions, deformations, or substitutions according to the concept of this application.

I claim:

1. A negative-pressure suction device for a tonsillolith, comprising: an electric base, a saliva bin, and a suction pipe, wherein a cavity is disposed in the electric base, a vacuum pump is disposed in the cavity, the vacuum pump is provided with a first connecting pipe and a second connecting pipe, the first connecting pipe communicates with the saliva bin, and the second connecting pipe communicates with the cavity; and
the suction pipe communicates with the saliva bin.

2. The negative-pressure suction device for a tonsillolith according to claim 1, further comprising a suction head, wherein the suction head is a bent pipe, the suction head is sleeved on the suction pipe, and the suction pipe communicates with the suction head.

3. The negative-pressure suction device for a tonsillolith according to claim 1, wherein the electric base comprises a front housing and a rear housing, the front housing is engaged with the rear housing to form the cavity, a circuit board and a battery are further installed in the cavity, a charging port, a switch, and a gear button are disposed on the circuit board, and a switch hole is opened and a gear button column is disposed on the front housing.

4. The negative-pressure suction device for a tonsillolith according to claim 1, wherein a conical pipe is disposed at a nozzle of the first connecting pipe, a bottom of the saliva bin is sleeved on the conical pipe and is not in tight contact with the conical pipe, and a gap is formed between the bottom of the saliva bin and the conical pipe; and an air duct that penetrates through a bottom plate is disposed on the bottom plate of the saliva bin, and the first connecting pipe, the gap, and the saliva bin communicate with each other through the air duct.

5. The negative-pressure suction device for a tonsillolith according to claim 4, wherein the saliva bin comprises a cylindrical bin pipe and a conical bin head, an upper part of the conical bin head is used for disposing the suction pipe, and a lower part of the conical bin head is detachably connected with the cylindrical bin pipe.

6. The negative-pressure suction device for a tonsillolith according to claim 2, wherein the suction pipe is detachably connected with the suction head.

7. The negative-pressure suction device for a tonsillolith according to claim 6, wherein curvature of the suction head comprises 45 degrees, 75 degrees, 90 degrees, and 135 degrees.
